(19) United States
(12) Patent Application Publication
(10) Pub. No.: US 2017/0207508 A1
(43) Pub. Date: Jul. 20, 2017

(54) FILTER COVER PLATE, FILTER AND MACHINING METHOD OF FILTER COVER PLATE

(71) Applicant: ZTE CORPORATION, Shenzhen City (CN)

(72) Inventors: Xiaowen DAI, Shenzhen City (CN); Yulong KANG, Shenzhen City (CN)

(73) Assignee: ZTE CORPORATION, Shenzhen City (CN)

(21) Appl. No.: 15/319,937

(22) PCT Filed: Sep. 3, 2014
(86) PCT No.: PCT/CN2014/085870

§ 371 Date: Dec. 19, 2016

(30) Foreign Application Priority Data
Jun. 17, 2014 (CN) 201410268754.5

(51) Int. Cl. H01P 1/207; H01P 11/00

(52) U.S. Cl. CPC H01P 1/207; H01P 11/007

(57) ABSTRACT

A filter cover plate, a filter and a machining method for the filter cover plate are described. A flanged threaded through-hole used for installing a tuning screw is provided on the filter cover plate. The flanged threaded through-hole has has a certain depth, and the thickness of other places on the cover plate is relatively thinner than the depth of the flanged threaded through-hole.

### CROSS-REFERENCE TO RELATED APPLICATION

This application is the U.S. national phase of PCT Application No. PCT/CN2014/085870 filed Sep. 3, 2014, which claims priority to Chinese Application No. 201410268754.5 filed Jun. 17, 2014, the disclosures of which are incorporated in their entirety by reference herein.

### TECHNICAL FIELD

The present document relates to the field of filters, and in particular, to a filter cover plate, a filter and a machining method for the filter cover plate.

### BACKGROUND

The existing filter is normally constructed by a plurality of resonant cavities, and a resonant cavity is formed by cooperation of a filter cavity body and a filter cover plate. By taking a coaxial-cavity filter as an example, a structure of the resonant cavity of the coaxial-cavity filter is as shown in FIG. 1, which includes a clamp nut 101, a threaded through-hole 102, a filter cover plate 103, a resonant cavity body 104 (also a part of the filter cavity body), a resonant column 105 and a tuning screw 106. The lower surface of the resonant column 105 is fixed at the bottom of the cavity body 104. The filter cover plate 103 and the resonant cavity body 104 are sealed via the screw to form a closed cavity. The tuning screw 106 enters the cavity via the threaded through-hole 102 on the cover plate 103, and a part of the tuning screw 106 is within the resonant column 105 for adjusting the frequency range of the resonant cavity and the tuning screw 106 is fixed on the filter cover plate 103 via the clamp nut 101. Since the threaded through-hole 102 and the clamp nut 101 jointly fasten the tuning screw 106, if the height of the through-hole is too low, the stability of the tuning screw 106 will be directly affected. The height of the threaded through-hole 102 is usually set as 3 mm-5 mm, which may ensure the stability of the tuning screw 106. Generally the thickness of the cover plate 103 is also 3 mm-5 mm since the threaded through-hole 102 is located on the cover plate 103.

As can be seen from FIG. 1, the resonant cavity is a completely closed cavity. An ideal conductor wall is called an electric wall in the electromagnetic theory, an electromagnetic wave incident on the electric wall will be completely reflected back, and no transmitted wave passes through the electric wall. Therefore, the electric wall is used to surround a closed cavity, once an electromagnetic wave with a proper frequency is fed in, the electromagnetic wave will be reflected back and forth on the electric wall of the closed cavity to form an electromagnetic standing wave within the closed cavity, and the electromagnetic resonance occurs. At this point, even though the external stops feeding energy to the inside of the closed cavity, the established electromagnetic resonance will keep without attenuation. A cavity constructed by a non-ideal conductor wall also has similar features of the cavity of the electric wall, nothing but the electromagnetic resonance established within the cavity will not keep for a long time after the external stops feeding energy and will attenuate little by little over time and finally vanish and become a damped vibration. A quality factor Q is an important parameter of the resonant cavity. The quality factor Q represents the frequency selectivity of the resonant cavity and the energy loss of the resonant cavity. A relation between the resonant cavity volume and the quality factor Q is that, the larger the resonant cavity volume is, the more electromagnetic energy stored by the resonant cavity is, and the larger the Q value is. The larger the Q value is, the lower the insertion loss of the filter is, thus the resonant cavity volume of the filter is increased, and the insertion loss may be reduced.

The outline dimension requirement of the entire filter is fixed, that is, the total height of the filter is fixed, thus the larger the thickness of the filter cover plate is and the smaller the cavity height of the resonant cavity is, then the smaller the actual volume of the resonant cavity is, the less the electromagnetic energy stored by the resonant cavity is, then the smaller the Q value is. The smaller the Q value is, the higher the insertion loss of the filter is, which severely affects the performance of the filter. Therefore, how to increase the resonant cavity volume in the filter becomes a key, and how to increase the volume of a single resonant cavity of the filter in the premise of same shape becomes an important research direction of the filter application.

### SUMMARY

The embodiments of the present document provide a filter cover plate, a filter and a machining method for the filter cover plate, which solves the problem that the resonant cavity volume is affected due to the thickness of the filter cover plate.

A filter cover plate provided in an embodiment of the present document includes a flanged threaded through-hole used for installing a tuning screw and provided on the filter cover plate.

The flanged threaded through-hole is optionally a uni-directional flanged threaded through-hole, and a flanging of the flanged threaded through-hole is towards an inner side of the filter cover plate.

In an example embodiment, a consolidating boss is further provided at a location corresponding to the flanged threaded through-hole on an outer side of the filter cover plate, and a strengthening rib is provided around the consolidating boss.

In an example embodiment, the flanged threaded through-hole is a bi-directional flanged threaded through-hole.

Another embodiment of the present document provides a filter, and the filter includes a cavity body, at least one resonant column and the above mentioned filter cover plate, the filter cover plate is fixed on the cavity body; the resonant column is provided within the cavity body, and a flanged threaded hole is provided at a location corresponding to the resonant column on the filter cover plate.

In an example embodiment, at least one resonant cavity body is provided within the cavity body of the filter, at least one resonant column is provided within each resonant cavity body, an axis of the resonant column is parallel to the cavity wall of the resonant cavity, and a bottom end of the resonant column is fixed at a bottom of the resonant cavity body.

In an example embodiment, a top end of the resonant column extends towards the periphery in a trumpet shape.

Still another embodiment of the present document provides a machining method for a filter cover plate, which includes: machining a cover plate material to obtain a cover plate base body; punching a flanged hole at a location where a tuning screw is installed on the cover plate base body by using a mold; and tapping within the flanged hole.

In an example embodiment, punching the flanged hole at the location where the tuning screw is installed on the cover plate base body by using the mold includes: punching a uni-directional flanged hole towards an inner side of the filter cover plate at the location where the tuning screw is installed on the cover plate base body by using the mold.

In an example embodiment, punching the flanged hole at the location where the tuning screw is installed on the cover plate base body by using the mold includes: punching a bi-directional flanged hole at the location where the tuning screw is installed on the cover plate base body by using the mold.

A flanged threaded through-hole used for installing a tuning screw is provided on a filter cover plate provided in the embodiment of the present document. The cover plate provided with the flanged threaded through-hole is characterized in that: the flanged threaded through-hole has a certain depth, and the thickness of other places on the cover plate is relatively thinner than the depth of the flanged threaded through-hole. Therefore, the flanged threaded through-hole is provided on the filter cover plate, and the tuning screw is fixed within the flanged threaded hole, which may reduce the thickness of the cover plate, and at the same time ensure that a tuning screw hole has enough number of threads to fix the tuning screw as well, thereby guaranteeing the stability of the tuning screw. The overall thickness of the filter cover plate is reduced, thereby increasing the volume of the resonant cavity of the filter, and then increasing the quality factor Q value, reducing the insertion loss of the filter, and improving the performance of the filter.

### BRIEF DESCRIPTION OF DRAWINGS

FIG. 1 is a structural schematic diagram of the resonant cavity of the filter in the existing technology.

FIG. 2 is a structural schematic diagram of a filter cover plate provided in an embodiment 1 of the present document cooperating with the tuning screw and the clamp nut.

FIG. 3 is a structural schematic diagram of another filter cover plate provided in an embodiment 1 of the present document cooperating with the tuning screw and the clamp nut.

FIG. 4 is a structural schematic diagram of yet another filter cover plate provided in an embodiment 1 of the present document cooperating with the tuning screw and the clamp nut.

FIG. 5 is a structural schematic diagram of a filter provided in an embodiment 2 of the present document.

FIG. 6 is a flow chart of a machining method for a filter cover plate provided in an embodiment 3 of the present document.

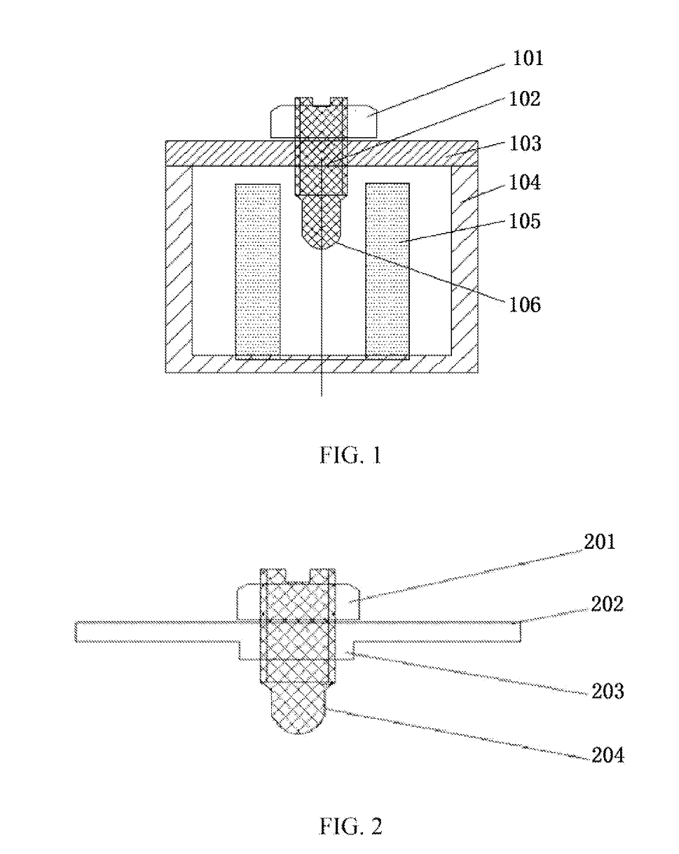

### SPECIFIC EMBODIMENTS

The embodiments of the present document will be described in detail in combination with the accompanying drawings below, the embodiments in the present document and the characteristics in the embodiments may be arbitrarily combined with each other in the case of no conflicts.

### Embodiment 1

The embodiment provides a filter cover plate, a flanged threaded through-hole used for installing a tuning screw is provided on the filter cover plate, and threads matched with the tuning screw are distributed in the flanged threaded through-hole. The flanged threaded through-hole may be a uni-directional flanged threaded through-hole or a bi-directional flanged threaded through-hole. The uni-directional flanged threaded through-hole refers to that the flanged threaded through-hole is only flanged towards one side of the cover plate, it may be flanged towards the inner side of the filter cover plate (the inner side of the cover plate refers to a side towards the filter cavity body) or be flanged towards the outer side of the filter cover plate. The bi-directional threaded through-hole refers to that the flanged threaded through-hole is flanged towards both the inner side and the outer side of the filter cover plate.

In order to further describe the filter cover plate provided in the embodiment, the filter cover plate will be described through an exemplary description below. With reference to FIG. 2, FIG. 2 is a structural schematic diagram of a filter cover plate provided in the embodiment cooperating with the tuning screw and the clamp nut. A flanged threaded through-hole 203 is provided on a filter cover plate 202, the flanged threaded through-hole 203 is used for installing a tuning screw 204, and a clamp nut 201 is used for fixing the tuning screw 204. In the figure, the flanged threaded through-hole 203 is a uni-directional flanged threaded through-hole, and it is flanged towards the inner side of the filter cover plate 202.

For the situation that the flanged threaded through-hole is the uni-directional flanged threaded through-hole, a consolidating boss may also be provided at a location corresponding to the flanged threaded through-hole on the filter cover plate to further increase the thickness of the location where the tuning screw is installed on the filter cover plate, so that the tuning screw can be installed on the filter cover plate more stably. Alternatively, a strengthening rib may also be provided around the consolidating boss, so that the consolidating boss can be fixed on the filter cover plate more stably, and then the tuning screw can be fixed within the flanged threaded through-hole more stably. If a plurality of resonant cavities are provided within the cavity body of the filter, an isolating rib will exist between adjacent resonant cavities. In order to better fix the tuning screw within the flanged threaded through-hole stably with the strengthening rib, the strengthening rib may be provided at a location corresponding to the isolating rib on the outer side of the cover plate. With reference to FIG. 3, FIG. 3 is a structural schematic diagram of another filter cover plate provided in the embodiment cooperating with the tuning screw and the clamp nut. Besides that a uni-directional flanged threaded through-hole 303 is provided on a filter cover plate 302 in FIG. 3, a consolidating boss 305 is provided at a location corresponding to the flanged threaded through-hole on the outer side of the filter cover plate 302 as well, the consolidating boss 305 is connected with the filter cover plate 302, and threads matched with threads of a tuning screw 304 are also provided at the inner side of the consolidating boss 305. A clamp nut 301 fastens the tuning screw 304 on the consolidating boss 305. A strengthening rib 306 is provided around the consolidating boss 305.

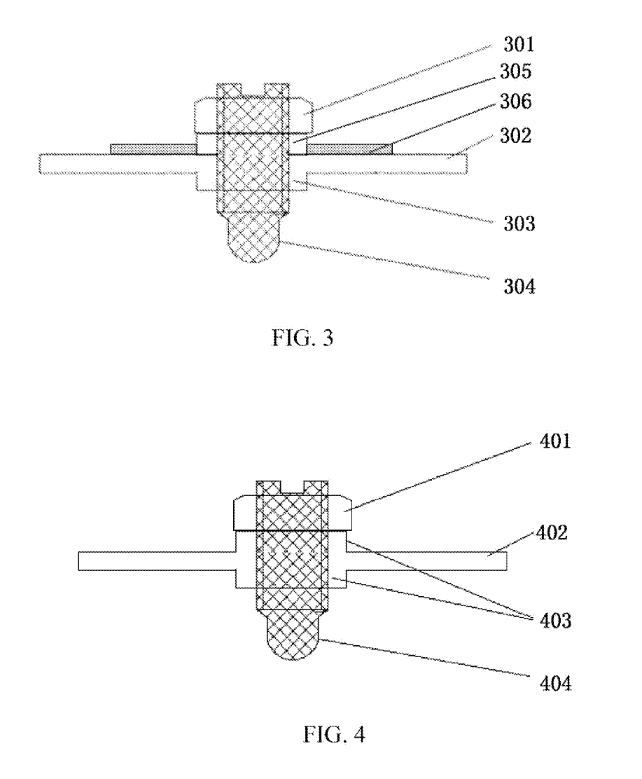

The embodiment also provides yet another filter cover plate, with reference to FIG. 4, FIG. 4 is structural schematic diagram of yet another filter cover plate provided in the embodiment cooperating with the tuning screw and the clamp nut. In the figure, a flanged threaded through-hole 403 is provided on a filter cover plate 402, the flanged threaded through-hole 403 is a bi-directional flanged threaded through-hole, and the flanged threaded through-hole 403 not only has a flanging towards the inner side of the filter cover plate but also has a flanging towards the outer side of the filter cover plate. The flanged threaded through-hole 403 is used for installing a tuning screw 404, and a clamp nut 401 is used for fixing the tuning screw 404. As can be seen from the comparison between FIG. 4 and FIG. 2, if the length of the flanging of the bi-directional flanged threaded through-hole 403 in FIG. 4 that is towards the inner side of the filter cover plate is the same as the length of the flanging of the uni-directional flanged threaded through-hole 203 in FIG. 2 that is towards the inner side of the filter cover plate, the depth of the bi-directional flanged threaded through-hole 403 in FIG. 4 will be greater than the depth of the uni-directional flanged threaded through-hole 203 in FIG. 2, thus the tuning screw 404 installed in FIG. 4 will be more stable. If the depth of the bi-directional flanged threaded through-hole 403 in FIG. 4 is the same as the depth of the uni-directional flanged threaded through-hole 203 in FIG. 2, the length of the flanging of the bi-directional flanged threaded through-hole 403 in FIG. 4 that is towards the inner side of the filter cover plate will be shorter than the length of the flanging of the uni-directional flanged threaded through-hole 203 in FIG. 2 that is towards the inner side of the filter cover plate, thus the volume of the resonant cavity of the filter will be increased, which improves the performance of the filter. It can be seen that the effect of providing the bi-directional threaded through-hole on the filter cover plate will be superior to providing the uni-directional threaded through-hole.

By using the filter cover plate provided in the embodiment, the thickness of the filter cover plate may be reduced by ⅔ and the cavity height of the resonant cavity of the filter may be increased by 1.5 mm-2 mm, which is more beneficial for the filter designing, improves the Q value of the resonant cavity of the filter, reduces the loss and greatly improves the performance of the filter. The thickness of the traditional cover plate is normally 2.5 mm or 3 mm, the thickness of the filter cover plate provided in the embodiment is 1.0 mm to 1.5 mm, the filter design space is increased when compared to the traditional cover plate. The increase of the cavity height of the resonant cavity of the filter and the tuning space of the tuning screw is more beneficial for designing. In addition, compared with a common cover plate, costs are reduced and material expenses are decreased. For example, cold-rolled plates are used for machining, and the materials cost is 30% of that of the traditional aluminum plates.

The materials of the filter cover plate in the embodiment may use metal with good electrical conductivity, such as aluminum plates, cold-rolled steel plates and copper plates.

### Embodiment 2

The embodiment provides a filter, the filter includes a filter cover plate and a cavity body, and the filter cover plate of the filter is the filter cover plate provided in the above embodiment 1. The filter cover plate is fixed on the cavity body. At least one resonant column is also provided within the filter, a flanged threaded through-hole is at a location corresponding to the resonant column within the cavity body on the filter cover plate, and after the cover plate is installed on the cavity body, a tuning screw entering the cavity via the flanged threaded through-hole is just within the resonant column. At least one resonant cavity body may be provided within the cavity body of the filter, when there is only one resonant cavity body within the filter, the cavity body of the filter is the cavity body of the resonant cavity. When a plurality of resonant cavity bodies are provided within the filter, it indicates that a plurality of sub-cavities exist within the filter, and each sub-cavity is isolated by an isolating rib within the cavity body of the filter. For a coaxial-cavity filter, it refers to that each resonant column within the resonant cavity is parallel to the cavity wall of the cavity body, and a bottom end of the resonant column is fixed at the bottom of the resonant cavity body. Alternatively, a top end of the resonant column may also be provided to extend outwards in a trumpet shape. For the coaxial-cavity filter, if a plurality of resonant columns are provided within the cavity body, a plurality of flanged threaded through-holes may also be accordingly provided on the filter cover plate.

In order to further describe the filter provided in the embodiment, the filter will be described through an exemplary example below. With reference to FIG. 5, FIG. 5 is a structural schematic diagram of a filter provided in an embodiment of the present application, the filter includes a filter cover plate 503 and a uni-directional flanged threaded through-hole 502 provided on the filter cover plate 503, the filter cover plate 503 is fixed on a cavity body 504 of the filter, a resonant column 505 is provided within the cavity body 504 of the filter, a tuning screw 506 enters a hollow portion of the resonant column within the resonant cavity via the uni-directional flanged threaded through-hole 502. A clamp nut 501 fixes the tuning screw 506 on the filter cover plate 503. An axis of the resonant column 506 is parallel to the cavity wall of the cavity body 504, a bottom end of the resonant column 506 is fixed at the bottom of the cavity body and a top end extends outwards in a trumpet shape.

### Embodiment 3

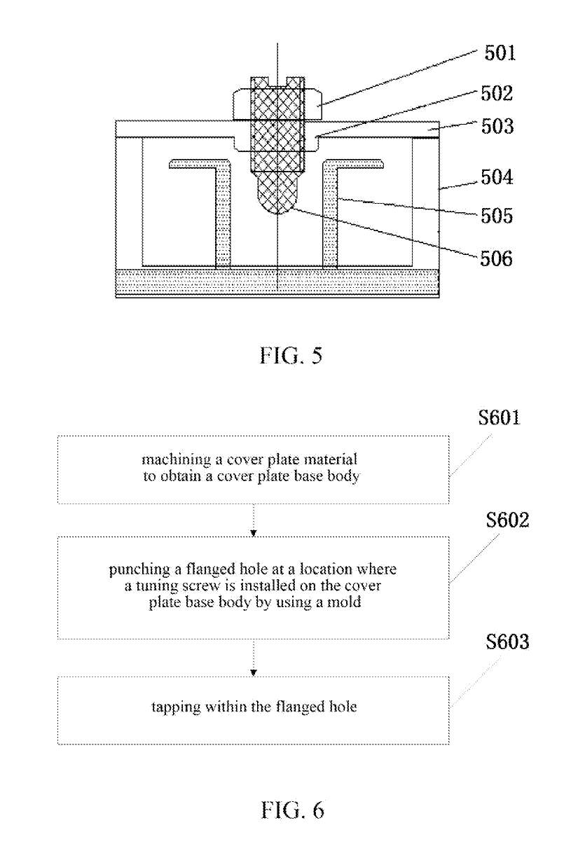

The embodiment provides a machining method for a filter cover plate, with reference to FIG. 6, FIG. 6 is a flow chart of the machining method, and the method includes the following steps.

In step S601, a cover plate material is machined to obtain a cover plate base body.

In step S602, a flanged hole is punched at a location where a tuning screw is installed on the cover plate base body by using a mold. Punching the flanged hole may specifically include: punching a flanged pre-hole and performing flanging at the flanged pre-hole by using the mold.

In step S603, tapping is performed within the flanged hole.

In the above step S602, the flanged hole may be uni-directional or bi-directional, thus punching the flanged hole at the location where the tuning screw is installed on the cover plate base body by using the mold may be punching a uni-directional flanged hole towards the inner side of the filter cover plate at the location where the tuning screw is installed on the cover plate base body by using the mold. It may also be punching a bi-directional flanged hole at the location where the tuning screw is installed on the cover plate base body by using the mold.

The above contents are further detailed descriptions of the present document made in combination with the specific embodiments, it shall not be affirmed that the specific embodiments of the present document are only limited to these descriptions. For those ordinary people skilled in the art to which the present document belongs, a plurality of simple deductions or substitutions may also be made in the premise of not departing from the concept of the present document, and all these simple deductions or substitutions shall be within the protection scope of the present document.

### INDUSTRIAL APPLICABILITY

In the embodiments of the present document, the overall thickness of the filter cover plate is reduced, thereby increasing the volume of the resonant cavity of the filter, and then increasing the quality factor Q value, reducing the insertion loss of the filter, and improving the performance of the filter.

1. A filter cover plate, comprising:
a flanged threaded through-hole used for installing a tuning screw and provided on the filter cover plate.

2. The filter cover plate of claim 1, wherein, the flanged threaded through-hole is a uni-directional flanged threaded through-hole, and a flanging of the flanged threaded through-hole is towards an inner side of the filter cover plate.

3. The filter cover plate of claim 2, wherein, a consolidating boss is further provided at a location corresponding to the flanged threaded through-hole on an outer side of the filter cover plate, and a strengthening rib is provided around the consolidating boss.

4. The filter cover plate of claim 1, wherein, the flanged threaded through-hole is a bi-directional flanged threaded through-hole.

5. A filter, comprising a cavity body, at least one resonant column and the filter cover plate of claim 1; wherein the filter cover plate is fixed on the cavity body; the resonant column is provided within the cavity body; and the flanged threaded hole is provided at a location corresponding to the resonant column on the filter cover plate.

6. The filter of claim 5, wherein, at least one resonant cavity body is provided within the cavity body of the filter, at least one resonant column is provided within each resonant cavity body, an axis of the resonant column is parallel to a cavity wall of the resonant cavity, and a bottom end of the resonant column is fixed at a bottom of the resonant cavity body.

7. The filter of claim 5, wherein, a top end of the resonant column extends towards periphery in a trumpet shape.

8. A machining method for a filter cover plate, comprising:
machining a cover plate material to obtain a cover plate base body;
punching a flanged hole at a location where a tuning screw is installed on the cover plate base body by using a mold; and
tapping within the flanged hole.

9. The machining method for the filter cover plate of claim 8, wherein, punching the flanged hole at the location where the tuning screw is installed on the cover plate base body by using the mold comprises: punching a uni-directional flanged hole towards an inner side of the filter cover plate at the location where the tuning screw is installed on the cover plate base body by using the mold.

10. The machining method for the filter cover plate of claim 8, wherein, punching the flanged hole at the location where the tuning screw is installed on the cover plate base body by using the mold comprises: punching a bi-directional flanged hole at the location where the tuning screw is installed on the cover plate base body by using the mold.

11. The filter of claim 6, wherein, a top end of the resonant column extends towards periphery in a trumpet shape.
